(19) United States
(12) Patent Application Publication
(10) Pub. No.: US 2005/0233050 A1
(43) Pub. Date: Oct. 20, 2005

(54) Healthy Carbonated Beverages/Soda

(75) Inventor: Fang Chen, North Wales, PA, PA (US)

Correspondence Address: FANG CHEN, 3409 CARRIAGE CT SOUTH, NORTH WALES, PA, 19454, US

(73) Assignee: Fang Chen, North Wales, PA (US)

(21) Appl. No.: 10/709,169

(22) Filed: Apr. 19, 2004

(51) Int. Cl. B67D 5/60

(52) U.S. Cl. 426/590

(57) ABSTRACT

A healthy and more nutritious carbonated beverages/soda formulation that will relieve the concerns from the public on carbonated beverages/soda drinking and health. In addition to traditional components (carbonated water, citric acid, natural flavor, preservatives), each can contains 10% or less daily value of the following ingredients: Calcium, Vitamin D₃, Magnesium, Vitamin C. Carrot juice or β-carotene provides precursors for Vitamin A. The sugar is about 50% of the current amount. Aspartame in reduced current amount can be used instead of sugar with the above components to make diet carbonated beverages/soda. Mint flavor can be added to the above formulations in addition to the tradition carbonated beverages/soda flavors. Variation of quantity, source of ingredients and composition of the above formulation can be made according to specific situation. Each person can drink one to two cans per day in addition to vitamin or calcium supplementation. Up to 10 cans can be consumed per person per day if no calcium or vitamin tablets intake. It is consumers' responsibility to follow the instruction on the label.

### SUMMARY OF INVENTION

Carbon dioxide is a colorless and odorless gas that we breathe out and plants under the Sun breathe in. It is the main ingredient that characterizes the carbonated beverages/soda. Beverages containing carbon dioxide possess a unique refreshing taste. It quickly became very popular and spread all over the world. It has been part of the American lifestyle for more than 100 years.

The commonly known carbonated beverages/soda all contain the following main ingredients: purified water, carbon dioxide, and/or syrup/sugar/aspartame, caffeine, citric acid, natural/artificial flavors and some kind of preservatives for freshness and color. Nutritionally, they can be classified as flavored liquid candy.

As people nowadays concern about health in addition to the taste of food they drink or eat, people start to question the nutrition value of the popular carbonated beverages/soda, especially various inexpensive but extremely tasty carbonated beverages/soda. Calcium is crucial in healthy bone metabolism. Low calcium level in the body can cause poor bone formation, or osteoporosis. People worry about that drinking carbonated beverages/soda will rob the bones of calcium. There are concerns over American youth drinking carbonated beverages/soda instead of milk, which reduces daily calcium intake. This will result in a generation with high incidence of osteoporosis. Carbonated beverages/soda containing caffeine is even worse because caffeine causes your body to secret calcium in your urine. Further more, high amount of sugar in the current carbonated beverages/soda is also related to the development of obesity. There are even worries about carbonated beverages/soda increasing incidences of kidney stone, tooth decay, etc. Carbonated beverages/soda is not a choice of drink for most public schools in Pennsylvania. Overall, the current carbonated beverages/soda is not considered healthy drink in spite of the fact that it is so tasty and it is more tempting to choose carbonated beverages/soda instead of milk or juice for a drink.

In order to keep the popularity of this unique, distinctive and refreshing taste of the carbonated beverages/soda but also to make it a healthy drink, the current invention propose the following modification to the current carbonated beverages/soda, such as those bottled by The Coca Cola Company, PEPSI or the like so as to relieve the concerns from the public.

First, the amount of sugar or aspartame will be reduced. In addition, nutritious ingredients, which will help to build healthy body and bone, will be added to the new formulated carbonated beverages/soda. The nutritious ingredients will be Calcium, Vitamin D₃, Magnesium, Vitamin C, carrot juice or □-Carotene.

Specifically, the following formulation will be used in make a line of healthy carbonated beverages/soda. The compositions, source of ingredients and amounts used in the following specific formulation are considered optimal in regard to health benefit. However, other variation of ingredient quantities, sources and compositions can be used in formulation according specific situation, such as availability or price.

For each standard can of soda (12 FL OZ or 355 ml), it contains the traditional ingredients, such as carbonated water, citric acid, natural flavor and preservatives. Sugar (corn syrup or sucrose) or aspartame (for diet) will be reduced to 50% of the current amount, which may be 20 g for sugar. It will contain 100 mg of Calcium (10% of daily value [DV]), in the form of 400 mg of Calcium Bicarbonate or Calcium citrate or Calcium Acetate, whichever is available. It will also contain 40 IU of Vitamin D₃ (10% DV), which is 1 μg. It contains 10 mg of Magnesium (2.5% DV) in the form of 59 mg Magnesium Acetate. It contains 120 IU of Vitamin C (10% DV) in the form of 6 mg of Ascorbic Acid or 6.7 mg Calcium Ascorbate, whichever is available. It will also contain 1.2 FL OZ of carrot juice, which provides natural Vitamin A precursors. Or the Vitamin A precursors can be 210 μg of □-carotene (7% DV). In addition to the traditional flavor, a new Mint flavored carbonated beverages/soda may be made by adding small amount of peppermint or spearmint oil. The water insoluble Vitamin D₃, β-carotene and mint oil can be dissolved in 0.1 ml of corn oil before mixing with the rest. Carrot juice can be extracted by grounding fresh carrot with one to two volumes of water and filtering.

The current formulation will ensure Calcium intake, subsequent absorption and healthy bone formation. As each can only contain 10% or less of the daily value of the indicated ingredient, up to 10 cans may be consumed per person per day if no calcium or multi-vitamin tablets are taken. One to two cans may be taken per person per day in addition to vitamin or calcium supplements.

The primary value of the current invention is that it solves a few of the problems related to current soda formulations, such as reduced Calcium intake, access amount of sugar intake, less nutritious value. The new formulated carbonated beverages/soda will be more acceptable by the public and school system.

### DETAILED DESCRIPTION

The following formulation will be used in make a line of healthy carbonated beverages/soda. The compositions, source of ingredients and amounts used in the following specific formulation are considered optimal in regard to health benefit. However, other variation of ingredient quantities, sources and compositions can be used in formulation according specific situation, such as availability or price.

The healthy carbonated beverages/soda contains the following ingredients per can of 12 FL OZ (355 ml):
1. Traditional components (carbonated water, citric acid, natural flavor, preservatives).
2. Sugar 20 g (corn syrup or sucrose) or aspartame (for diet).
3. Calcium 100 mg (10 DV) from 400 mg of Calcium Bicarbonate or Calcium citrate or Calcium Acetate, whichever is available.
4. Vitamin D₃ 40 IU (10% DV) from 1 μg of Vitamin D₃.
5. Magnesium 10 mg (2.5% DV) from 59 mg Magnesium Acetate.
6. Vitamin C 120 IU (10% DV) from 6 mg of Ascorbic Acid or 6.7 mg Calcium Ascorbate, whichever is available.
7. Carrot juice 1.2 FL OZ extracted from fresh carrot, which provides natural Vitamin A precursors, or 210 μg of β-carotene (7% DV).
8. (Optional) mint flavor by adding trace amount mint oil.
9. Corn oil 0.1 ml to dissolve Vitamin D3, and/or β-carotene, and/or mint.

As each can only contain 10% or less of the daily value of the indicated ingredient, up to 10 cans may be consumed per person per day if no calcium or multi-vitamin tablets are taken. One to two cans may be taken per person per day in addition to vitamin or calcium supplements. It is consumers' own responsibility in using this new invention appropriately and following the instructions on the label. This new invention will help to build strong and healthy bodies for carbonated beverages/soda generations.

1. An improved formulation of the carbonated beverages/soda by reducing sugar and adding in nutritious ingredients: Calcium, Vitamin D₃, Magnesium, Vitamin C, Carrot juice or β-carotene.

2. A formulation according to claim 1 wherein the nutritious ingredients can be varied, such as in quantity, composition and source of ingredient.

3. A formulation according to claim 1 wherein the flavor can be mint in addition to the traditional flavors in carbonated beverages/soda.

4. A formulation according to claim 1 wherein the sugar can be aspartame in reduced current amount to make diet carbonated beverages/soda.
